(19) United States
(12) Patent Application Publication
(10) Pub. No.: US 2005/0284575 A1
(43) Pub. Date: Dec. 29, 2005

(54) Processing system and operating method of processing system

(75) Inventors: Kazuhide Hasebe, Tokyo-To (JP); Atsushi Endo, Tokyo-To (JP); Mitsuhiro Okada, Tokyo-To (JP); Jun Ogawa, Tokyo-To (JP); Akihito Yamamoto, Yokohama-Shi (JP); Takashi Nakao, Danbury, CT (US); Masaki Kamimura, Yokohama-Shi (JP); Yukihiro Ushiku, Yokohama-Shi (JP)

Correspondence Address: SMITH, GAMBRELL & RUSSELL, LLP, 1850 M STREET, N.W., SUITE 800, WASHINGTON, DC, 20036, US

(73) Assignees: TOKYO ELECTRON LIMITED; KABUSHIKI KAISHA TOSHIBA

(21) Appl. No.: 11/196,398

(22) Filed: Aug. 4, 2005

Related U.S. Application Data
(63) Continuation of application No. PCT/JP04/01110, filed on Feb. 4, 2004.

(30) Foreign Application Priority Data
Feb. 4, 2003 (JP) 2003-27546

(51) Int. Cl. C23F 1/00; B44C 1/22

(52) U.S. Cl. 156/345.37; 216/58

(57) ABSTRACT

A processing system of the present invention includes: a reaction container in which a substrate to be processed is placed, a process-gas supplying mechanism that supplies a process gas into the reaction container at a process to the substrate, a cleaning-gas supplying mechanism that supplies a corrosive cleaning gas into the reaction container at a cleaning process, a gas-discharging-way member connected to the reaction chamber, a heating unit that heats a specific portion of the reaction container and the gas-discharging-way member, a temperature detecting unit that detects a temperature of the specific portion, a temperature controlling unit that controls the heating unit based on a detection value detected by the temperature detecting unit in such a manner that the specific portion becomes to a predetermined target temperature, and a temperature changing unit that changes the target temperature between at the process to the substrate and at the cleaning process. By means of the temperature changing unit, the target temperature is set to a temperature at which adhesion of reaction by-products to the specific portion may be inhibited, at the process to the substrate, while the target temperature is set to a temperature at which corrosion of the specific portion may be inhibited, at the cleaning process.

### FIELD OF THE INVENTION

The present invention relates to a processing system such as a low-pressure CVD (chemical vapor deposition) unit that periodically conducts a cleaning process to an inside of a reaction container by means of a cleaning gas, and to an operating method of the processing system.

### DESCRIPTION OF THE RELATED ART

When a film-forming process is conducted by using a low-pressure chemical vapor deposition unit (to be referred to as a LP-CVD unit hereinafter) that is one of semiconductor producing units, reaction by-products may be occasionally generated in large quantities. For example, in an LP-CVD unit in which a silicon nitride film is formed by using dichloro-silane (SiH₂Cl₂) and ammonia (NH₃), ammonium chloride (NH₄Cl) which is a reaction by-product is generated in large quantities at a film-forming process. In this case, when a temperature of an inside wall of a gas-discharging pipe which is a gas-discharging portion of the LP-CVD unit is not more than a sublimation temperature of the reaction by-product, this reaction by-product adheres to the gas-discharging portion in large quantities and causes a negative effect such as clogging up a vacuum pump which keeps an inside of the reaction container and the gas-discharging portion to be a vacuum. Therefore, in this LP-CVD unit, the gas-discharging portion is adapted to be heated not less than the sublimation temperature of the reaction by-product so that the reaction by-product will not adhere to the gas-discharging portion.

In addition, when a film-forming process is conducted by using this LP-CVD unit, a silicon nitride film adheres not only to a film-formed surface of a semiconductor wafer (to be referred to as a wafer hereinafter) but also to the inside wall of the reaction container, a carrying equipment for holding the wafer, and the like. When a cumulative film thickness of this silicon nitride film grows to a certain thickness, a film flaking occurs, so that contamination and dust will be increased. Moreover, it has been also found out that temperature stability in the reaction container may be influenced due to a change in a radiation rate of inner compositions of the reaction container. These may become causes to lower a yield of products. Consequently, it is necessary to conduct a cleaning process to the inside of the LP-CVD unit periodically and to remove the silicon nitride film which adheres to the inside wall of the reaction container and the carrying equipment.

As a cleaning method, a dry etching method is widely used, in which a corrosive etching gas, for example, a chlorine trifluoride (ClF₃) is introduced into the LP-CVD unit and a chemical reaction between the corrosive etching gas and the silicon nitride film is applied (reference to, for example, Japanese Patent Laid-Open Publication 2000-77391).

By the way, the use of the ClF₃ gas is recently being limited in terms of environmental problems. Instead of this gas, the use of a cleaning gas including an F₂ gas, for example, a mixture gas of a fluorine (F₂) gas and a hydrogen fluoride (HF) gas is being examined.

However, since the F₂ gas is extremely corrosive, when a cleaning gas including the F₂ gas is introduced in order to clean the silicon nitride film adhering to the inside of the reaction container under a condition wherein the gas-discharging portion is heated not less than the sublimation temperature of a reaction by-product, a coating layer of a stainless-steel member of the gas-discharging portion, for example, may be damaged. In this case, the stainless-steel member may be exposed and corroded. In other words, the gas-discharging portion itself may be damaged. In addition, when a silicon nitride film is formed by using the LP-CVD unit under a condition wherein the stainless-steel member of the gas-discharging portion has been corroded, a reaction product between the stainless-steel and the cleaning gas (for example, CrF₂) may be captured into the silicon nitride film. In this case, it has been recognized that the quality of the formed silicon nitride film such as electric characteristics and reliability and the like is affected. Additionally, the reaction product between the stainless-steel and the fluorine also acts as a catalyzer in forming the silicon nitride film. Accordingly, an extraordinary growth of the silicon nitride film may occur at a point where the reaction product adheres. This can considerably impair wafer's in-plane uniformity of the silicon nitride film formed on the surface of the wafer.

Moreover, when a cleaning process is conducted to the LP-CVD unit under an unexperienced pressure and/or temperature condition, there was conventionally not any method to confirm a corrosive degree of the gas-discharging portion except for checking it with eyes. Therefore, there may be a case wherein the LP-CVD unit is used although the gas-discharging portion has been corroded, and hence problems may be raised in the quality of film-formed products and the gas-discharging portion itself may be even destroyed.

### SUMMARY OF THE INVENTION

The present invention is made considering the above problems which a processing system (for example, an LP-CVD unit for forming a silicon nitride film) has conventionally had, wherein a member to be heated in order to inhibit an adhesion of a reaction by-product (for example, a gas-discharging-way member) is probably to be corroded when a corrosive cleaning gas is flown into the inside of the unit, has conventionally had, and is aiming to provide a processing system and an operating method of the processing system in which it is possible to inhibit the corrosion of a stainless-steel portion of, for example, a gas-discharging-way member to a minimum. Additionally, another invention is aiming to provide a processing system and an operating method of the processing system, in which it is possible to change a temperature of, for example, a gas-discharging-way member and also a cleaning process is finished automatically according to a reaction status between a stainless-steel portion of the gas-discharging-way member and a cleaning gas.

The present invention is a processing system comprising: a reaction container in which a substrate to be processed is placed, a process-gas supplying mechanism that supplies a process gas into the reaction container at a process to the substrate, a cleaning-gas supplying mechanism that supplies a corrosive cleaning gas into the reaction container at a cleaning process, a gas-discharging-way member connected to the reaction chamber, a heating unit that heats a specific portion of the reaction container and the gas-discharging-way member, a temperature detecting unit that detects a temperature of the specific portion, a temperature controlling unit that controls the heating unit based on a detection value detected by the temperature detecting unit in such a manner that the specific portion becomes to a predetermined target temperature, and a temperature changing unit that changes the target temperature between at the process to the substrate and at the cleaning process, wherein by means of the temperature changing unit, the target temperature is set to a temperature at which adhesion of reaction by-products to the specific portion may be inhibited, at the process to the substrate, while the target temperature is set to a temperature at which corrosion of the specific portion may be inhibited, at the cleaning process.

According to the present invention, not only adhesion of a reaction by-product at the process may be inhibited, but also corrosion at the cleaning process may be inhibited in the specific portion of the reaction container and the gas-discharging-way member (the gas-discharging-way member, a lid to close an opening of the reaction container, and the like). Accordingly, a durable term of the portion can be extended.

Preferably, a processing system further comprises a cooling unit that cools a part of the specific portion.

Preferably, a processing unit further comprises a reaction detecting unit that detects a reaction between a part of the specific portions and the cleaning gas at the cleaning process. In this case, it is preferable that the temperature changing unit is adapted to change the target temperature at the cleaning process into a lower target temperature, when the reaction detecting unit detects a reaction between the specific portion and the cleaning gas. Furthermore, it is preferable that supply of the cleaning gas by means of the cleaning-gas supplying mechanism is adapted to be stopped, when the temperature changing unit changes the target temperature at the cleaning process into a predetermined lower-limit temperature.

Moreover, it is preferable that a processing system further comprises a system controlling unit that controls the process to the substrate caused by the process gas, and a management controlling unit that conducts an overall step management, wherein the temperature changing unit is integrated with the management controlling unit.

In this case, preferably, the management controlling unit is adapted to determine an introduction timing of the cleaning gas based on information sent from the system controlling unit, and the temperature changing unit is adapted to change the target temperature by the introduction timing.

Preferably, the cleaning gas includes a fluorine gas.

Preferably, the specific portion is a portion of the gas-discharging-way member or a whole portion of the gas-discharging-way member.

Additionally, the preset invention is an operating method of a processing system including: a reaction container in which a substrate to be processed is placed, a process-gas supplying mechanism that supplies a process gas into the reaction container at a process to the substrate, a cleaning-gas supplying mechanism that supplies a corrosive cleaning gas into the reaction container at a cleaning process, a gas-discharging-way member connected to the reaction chamber, and a heating unit that heats a specific portion of the reaction container and the gas-discharging-way member, the operating method comprising: a step of conveying the substrate into the reaction container, a step of heating the specific portion to a temperature at which adhesion of reaction by-products to the specific portion may be inhibited, a step of supplying the process gas into the reaction container to conduct a process to the substrate, a step of conveying out the substrate from the reaction container, a step of setting the specific portion to a temperature at which corrosion of the specific portion may be inhibited, and a step of supplying the cleaning gas into the reaction container to conduct a cleaning process to the reaction container.

According to the present invention, not only adhesion of a reaction by-product at the process may be inhibited, but also corrosion at the cleaning process may be inhibited in the specific portion of the reaction container and the gas-discharging-way member (the gas-discharging-way member, a lid to close an opening of the reaction container, and the like). Accordingly, a durable term of the portion can be extended.

Preferably, the step of setting the specific portion to a temperature at which corrosion of the specific portion may be inhibited includes a step of forcibly cooling the specific portion.

Furthermore, preferably, the step of supplying the cleaning gas into the reaction container to conduct a cleaning process to the reaction container includes a step of monitoring a reaction between the specific portion and the cleaning gas.

In this case, preferably, the step of supplying the cleaning gas into the reaction container to conduct a cleaning process to the reaction container includes a step of lowering the temperature of the specific portion further more when the reaction between the specific portion and the cleaning gas is detected.

In this case, further preferably, the step of supplying the cleaning gas into the reaction container to conduct a cleaning process to the reaction container includes a step of stopping the supply of the cleaning gas by means of the cleaning-gas supplying mechanism when the temperature of the specific portion is lowered to a predetermined lower-limit temperature.

### BRIEF DESCRIPTION OF THE DRAWINGS

FIG. 1 is an overall structural view showing a processing system according to an embodiment of the present invention;

FIG. 2 is a structural view showing a controlling system in the processing system according to an embodiment of the present invention;

FIG. 3 is a flowchart showing an operation of the processing system according to an embodiment of the present invention;

FIG. 4 is a flowchart showing another operation of the processing system according to an embodiment of the present invention; and

FIG. 5 is an explanatory view showing a target temperature of the gas-discharging-portion in the processing system according to an embodiment of the present invention.

### DESCRIPTION OF THE PREFERRED EMBODIMENT

Hereinafter, an LP-CVD unit to form a silicon nitride film, which is an embodiment of the present invention, will be described in detail with reference to the accompanying drawings.

In this embodiment, an optimum temperature control is conducted to a gas-discharging portion (a gas-discharging-way member) of the LP-CVD unit to form a silicon nitride film.

For example, time information about a cleaning step is adapted to be obtained from a system controlling unit which controls the LP-CVD unit itself. For example, heater power data are adapted to be obtained from a heater of the gas-discharging portion of the LP-CVD unit. Temperature detection data are adapted to be obtained from a temperature detecting unit attached to the gas-discharging portion, and analyzing data are adapted to be obtained from an analyzing unit for discharged gas components, attached to the LP-CVD unit. Based on these data, a gas-discharging-portion temperature-control-operation determining unit conducts an optimum temperature control of the gas-discharging portion according to a gas-discharging-portion temperature-control-operation determining program.

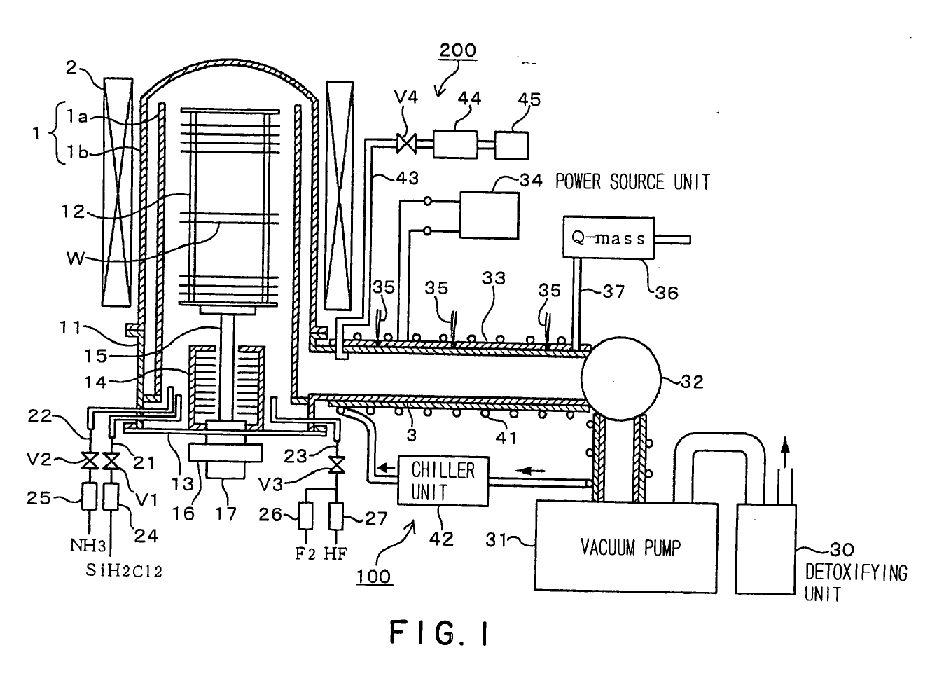

FIG. 1 is an overall structural view showing a processing system according to this embodiment. In FIG. 1, a reaction pipe 1 has a double structure composed of an inner pipe 1a and an outer pipe 1b, which are made of, for example, quartz. At a lower side of the reaction pipe 1, a metallic, for example, stainless-steel cylindrical manifold 11 is provided. An upper end of the inner pipe 1a is opened, and the inner pipe 1a is supported at an inner side of the manifold 11. An upper end of the outer pipe 1b is closed and its lower end is hermetically joined to an upper end of the manifold 11. In this example, a reaction container is composed of the reaction pipe 1 and the manifold 11.

FIG. 1 shows a condition wherein a wafer W that is a substrate is conveyed into the reaction pipe 1. In the reaction pipe 1, a plurality of wafers W are horizontally placed on a wafer boat 12 made of quartz, which is a holding equipment, with a vertical space between each other in a tier-like manner. The wafer boat 12 is supported by a rotation shaft 15 extending upward from the lid 13. The rotation shaft 15 is surrounded by a heat-retaining unit 14 made of quartz. The heat-retaining unit 14 is composed of an insulation unit such as a quartz fin. The lid 13 is placed on a boat elevator 16 for conveying the wafer boat 12 into or out of the reaction pipe 1, and has a function to close the lower end opening of the manifold 11 when the lid 13 is at an upper limit position. The rotation shaft 15 rotates by means of a driving portion 17 provided on the boat elevator 16 under the lid 13. Thereby, the wafer boat 12 rotates.

Around the reaction pipe 1, a heater 2 that is a heating unit composed of, for example, a resistance heating element, is provided so as to surround the reaction pipe 1. A not-shown furnace is provided around the heater 2. In addition, around the reaction pipe 1, a first film-forming gas supplying pipe 21 and a second film-forming gas supplying pipe 22, which are supplying pipes of processing gases, and a cleaning gas supplying pipe 23 are provided so as to be capable of supplying the respective gases into the inner pipe 1a. The first film-forming gas supplying pipe 21 and the second film-forming gas supplying pipe 22 are the pipes to respectively supply a dichloro-silane (SiH₂Cl₂) gas and an ammonia (NH₃) gas, and are connected to not-shown gas-supplying sources. A base side of the cleaning-gas supplying pipe 23 is branched so as to be capable of supplying a fluorine gas and a hydrogen fluoride gas respectively through both branched pipes. The signs V1 to V3 are valves composed of, for example, an air valve for supplying a gas and stopping the supply. The numeral signs 24 to 27 are mass flow controllers for adjusting gas flow rates.

A gas-discharging pipe 3 which is the gas-discharging-way member forming a gas-discharging portion made of metal, for example, stainless-steel is connected to the manifold 11 in order to discharge a gas from a space between the inner pipe 1a and the outer pipe 1b. The gas-discharging pipe 3 is connected to a vacuum pump 31 that is a vacuum gas-discharging unit. In addition, the gas-discharging pipe 3 has a main valve 32 on the way. By opening and/or closing the main valve 32, the inside of the outer pipe 1b and the vacuum pump 31 are able to be communicated and/or discommunicated. Moreover, by adjusting an opening degree of the main valve 32, a pressure in the reaction container can be controlled. A gas discharged from the vacuum pump 31 is released to the atmospheric air through a detoxifying (harm-eliminating) unit 30.

Around the outer periphery of the gas-discharging pipe 3, for example, a tape-type of gas-discharging-portion heater 33, which is a heating unit capable of heating the inside wall of the gas-discharging pipe 3, is provided with a winded condition. To the gas-discharging-portion heater 33, electric power is supplied from a power source unit 34.

Additionally, around the outer periphery of the gas-discharging pipe 3, a cooling pipe 41 as a flow passage member is provided so that a cooling fluid to cool the gas-discharging pipe 3 flows from a side of the manifold 11 to a side of the vacuum pump 31, that is, from an upstream side to a down stream side of the gas-discharging way. The cooling fluid is adapted to be cooled to a predetermined temperature by a chiller unit 42. For example, water is used as a cooling fluid, but other various kinds of cooling fluids such as H₂, He, oil, air and the like may be also used. In this example, the cooling pipe 41 and the chiller unit 42 compose a first cooling unit (an outside cooling unit) 100 to cool the outside of the gas-discharging pipe 3.

Moreover, in order to cool the inside wall of the gas-discharging pipe 3, a cooling-gas line 43 may be provided as a second cooling unit (an inside cooling unit) 200 to supply a cooling gas to the inside of the gas-discharging pipe 3, in addition to the first cooling unit 100 or instead of the first cooling unit 100. A supplying port of the cooling gas line 43 may be located at a position near to an upstream end of the gas-discharging pipe 3. As a cooling gas, a gas whose thermal conductivity is high and which does not react with materials composing the inside wall of the gas-discharging pipe 3, for example, H₂, He, an inert gas such as N₂, and the like can be used. The base side of the cooling gas line 43 is connected to the gas-supplying source 45 via a valve V4 and a flow-rate adjusting unit 44. The second cooling unit 200 can be used except when the main valve 32 is closed.

The gas-discharging pipe 3 is provided with a plurality of gas-discharging-portion thermocouples 35 that serves as a temperature detecting unit to detect a temperature of the gas-discharging pipe 3, for example, in a gas-discharging direction. The thermocouple 35 can be substituted by other various temperature detectors such as, for example, a thermistor and a pyrometer.

Furthermore, the processing system of the present invention is provide with a quadrupole mass spectrometer (to be abbreviated as a Q-mass hereinafter) 36 that serves as a reaction detecting unit in order to be capable of monitoring a reaction between a stainless-steel member composing the gas-discharging pipe 3 and the cleaning gas which is a corrosive etching gas. In this example, a gas exiting in the just upstream of the main valve 32 is adapted to be collected by a sampling pipe 37. The Q-mass 36 has a function to analyze density information of a component included in the gas within the gas-discharging pipe 3, for example CrF₂, as a type of ion current, and to send the result to a storage unit (recording medium) to be described later in real time as a component data of the gas within the gas-discharging pipe. Although the Q-mass is used in the present embodiment as a gas analyzing unit that is a reaction detecting unit, the present invention is not limited to this composition, and hence a reaction analysis of the inside wall of the gas-discharging pipe 3 may be carried out by using other reaction analyzing units, for example, a unit in which a reaction condition is speculated based on a reaction heat in the gas-discharging pipe 3.

In the embodiment described above, the inside of the gas-discharging pipe 3 is heated by the heating unit, the gas-discharging pipe 3 is cooled by the cooling unit, and the reaction condition between the stainless-steel member of the gas-discharging pipe 3 and the gas is monitored. However, heating and cooling may be conducted not only to the gas-discharging pipe 3 itself but also to a whole portion of the gas-discharging-way member, that is, to the intermediate units such as the main valve 32 and so on as well as the gas-discharging pipe, so as to detect the reaction with the gas.

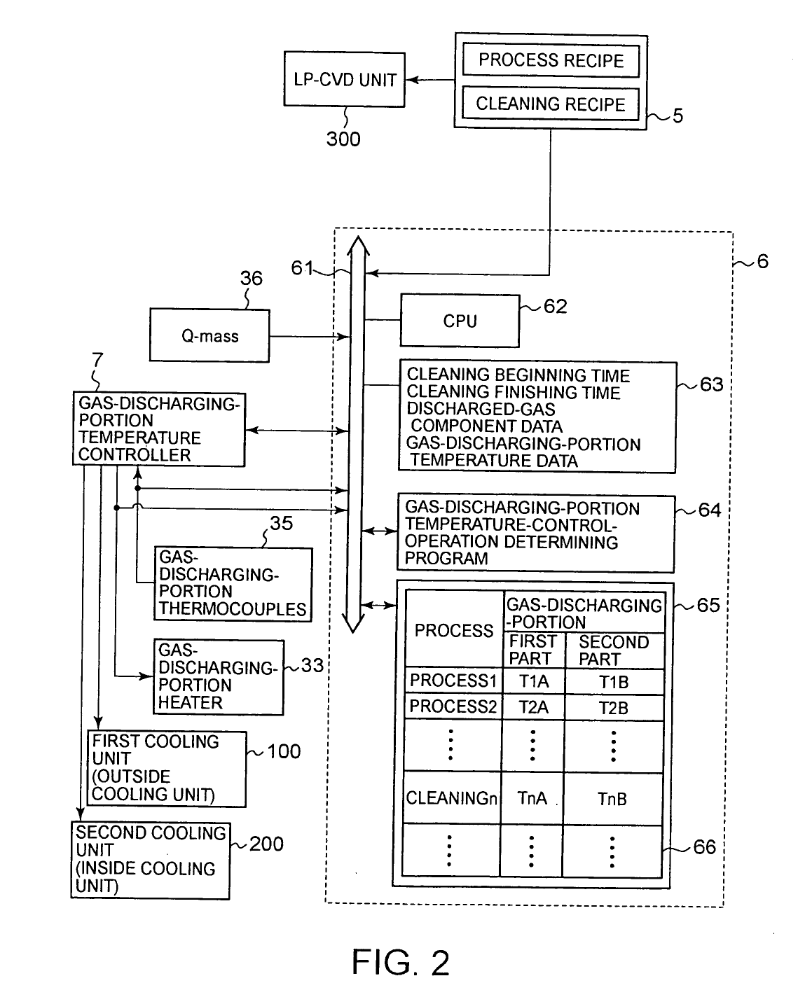

FIG. 2 is a structural view showing a controlling system in the processing system of the present embodiment. In the Figure, a system controlling unit 5 composed of, for example, a computer is provided with a process recipe, a cleaning recipe and the like. In these recipes, for example, a target temperature of the inside wall of the gas-discharging pipe 3 is included. The system controlling unit 5 controls a process temperature, a process pressure, gas flow rates and the like of the LP-CVD unit 300 at a process or at a cleaning process, while the system controlling unit 5 has a function to send information about the target temperature of the inside wall of the gas-discharging pipe 3, a beginning time (start time) and a finishing time (end time) of the cleaning process, and the like, to the controlling unit 6 to be described later. Note that the beginning time of the cleaning process is a time when a cleaning recipe is selected and the unit 300 begins to operate towards a processing condition such as a pressure and a temperature which are determined by the recipe.

As shown in FIG. 2, the controlling unit 6, for example, composed of a computer other than that of the system controlling unit 5 has a bus 61, a CPU (Central Processing Unit) 62, a first storage unit (recording medium) 63, a gas-discharging-portion temperature-control-operation determining program (a storage unit which stores the program) 64 and a second storage unit 65. The Q-mass 36 and the gas-discharging-portion temperature controller 7 as a gas-discharging-portion temperature controller are connected to the controlling unit 6. The controlling unit 6 may be composed as a management controlling unit, which totally manages a series of producing steps including a development of a device to be formed on a wafer, a process to a substrate, and an assemble of a unit, and information about the series of producing steps, by using both various information communication networks and date bases. In this case, a communication unit (not shown) may be provided to send and/or receive information to one or a plurality of units in which a prior step or a posterior step of the step conducted in the LP-CVD unit shown in FIG. 1 is conducted.

The gas-discharging-portion temperature controller 7 conducts a PID-control to the gas-discharging-portion heater 33 via the power source unit 34, based on the target temperature and a temperature detection valve from the thermocouples 35, so that the inside wall of the gas-discharging pipe 3 becomes not less than the sublimation temperature when the silicon nitride film is formed. In other words, a difference between the temperature detection valve and a temperature set valve corresponding to the target temperature is controlled with PID by a PID processing circuit, and is used to determine an electric power supply to the gas-discharging-portion heater 33.

In addition, in the second storage unit 65, a table 66 that is information relating each process or each cleaning process with a target temperature of the inside wall of the gas-discharging pipe 3 (a target temperature of the gas-discharging portion) is stored. For example, the table 66 is created in the system controlling unit 5 in advance, and then loaded from the system controlling unit 5. Alternatively, the table 66 is created in the controlling unit 6 based on data loaded from the system controlling unit 5. In the table 66 of this example, respective valves of a first part and a second part are recorded as a target temperature of the gas-discharging portion. When the inside wall of the gas-discharging portion 3 is divided into a plurality of parts in a discharging direction, for example, when it is divided into a part near to the reaction container and a part away from the reaction container, it is preferable that a heating unit (for example, a heater), a temperature detection unit (for example, a thermocouple), an electric power source unit and a gas-discharging-portion temperature controller are provided for each part so that a temperature control is independently carried out for each part.

In FIG. 1, although only one heater 33 is shown and it is described such that the temperature of the inside wall of the gas-discharging pipe 3 is controlled altogether, for example, the temperature of the part near to the reaction container and the temperature of the part away from the reaction container can be actually controlled independently. Therefore, the part near to the reaction container is referred to as the first part, and the part away from the reaction container is referred to as the second part, and the respective target temperatures are set. Since the first part is a part into which a gas heated in the reaction container flows, for example, a temperature lower than that of the second part is set. To take an example, the target temperature of the first part and the target temperature of the second part at a cleaning process are set to be 20° C. and 25° C., respectively. Incidentally, the target temperature of the first part and the target temperature of the second part at a process are set to be, for example, 180° C. and 200° C., respectively.

These gas-discharging-portion target temperatures may be determined according to types of gases in use, materials of the gas-discharging pipe 3 (especially, a coating material of the inside surface thereof) and the like, and can be inputted by an operator, for example via a control panel, for example in the system controlling unit 5. These target temperatures of the gas-discharging portion are read out in response to a process to be conducted in the reaction container, for example according to the gas-discharging-portion temperature-control-operation determining program 64, and are sent to the gas-discharging-portion temperature controller 7.

When the inside of the reaction container is cleaned, the controlling unit 6 as the gas-discharging-portion temperature-control-operation determining unit determines the target temperature(s) of the inside wall of the gas-discharging pipe 3, which is the gas discharging portion according to the gas-discharging-portion temperature-control-operation determining program 64. That is, the target temperature for a film-forming process is changed to the target temperature suitable for a cleaning process. The gas-discharging-portion temperature controller 7 operates the gas-discharging-portion heater 33 in order to achieve the target temperature(s). In this example, change of the target temperature(s) is conducted by reading out the target temperature(s) from the table 66.

In this embodiment, the gas-discharging-portion temperature-control-operation determining program 64, the CPU 62 and the table 66 compose a temperature changing unit in order to change the target temperature(s) of the inside wall of the gas-discharging pipe 3. The temperature detection values of the thermocouples 35 are sent to the gas-discharging-portion temperature controller 7 and are sampled by the controlling unit 6 periodically (in this embodiment, every 10 seconds) to be stored in the storage unit 63.

Furthermore, when the gas-discharging-portion temperature controller 7 receives a cooling command from the controlling unit 6 based on determination of a cooling operation in accordance with the gas-discharging-portion temperature-control-operation determining program, the gas-discharging-portion temperature controller 7 operates the first cooling unit 100 accordingly. Concretely, for example, it sends a flow command to the chiller unit 42. When the chiller unit 42 receives the flow command, it makes the fluid flow into the cooling pipe 41 that surrounds the gas-discharging pipe 3. Thereby, the temperature of the gas-discharging pipe 3 is lowered further more. There is no problem even when any fluid is used if the fluid has a high thermal conductivity. In the present embodiment, water whose temperature is [5 [C.°] and whose flow rate is 5 to 15 [l/min] is caused to flow.

In the controlling unit 6, the storage unit 63 stores information such as: the beginning time of the cleaning process and the finishing time of the cleaning process sent from the system controlling unit 5, the data of discharged-gas components sent from Q-mass 36, the temperature detection values sent from the gas-discharging-portion thermocouples 35, the heater output sent from the gas-discharging-portion heater 33, and the like. The gas-discharging-portion temperature-control-operation determining program 64 determines the gas-discharging-portion target temperature(s) based on the above information that has been sent to the storage unit 63 to be stored. According to necessity, the gas-discharging-portion temperature-control-operation determining program 64 creates a cooling operation command for the first cooling unit 100. Incidentally, when the second cooling unit 200 is provided, a cooling operation command for the second cooling unit 200 may be created based on the above information. When a cooling condition is controlled by the first cooling unit 100 or the second cooling unit 200, it is possible not only to select from a flow condition and a flow-stop condition of the cooling fluid or gas based on the target temperature(s) and/or the temperature detection values, but also to control the flow rate.

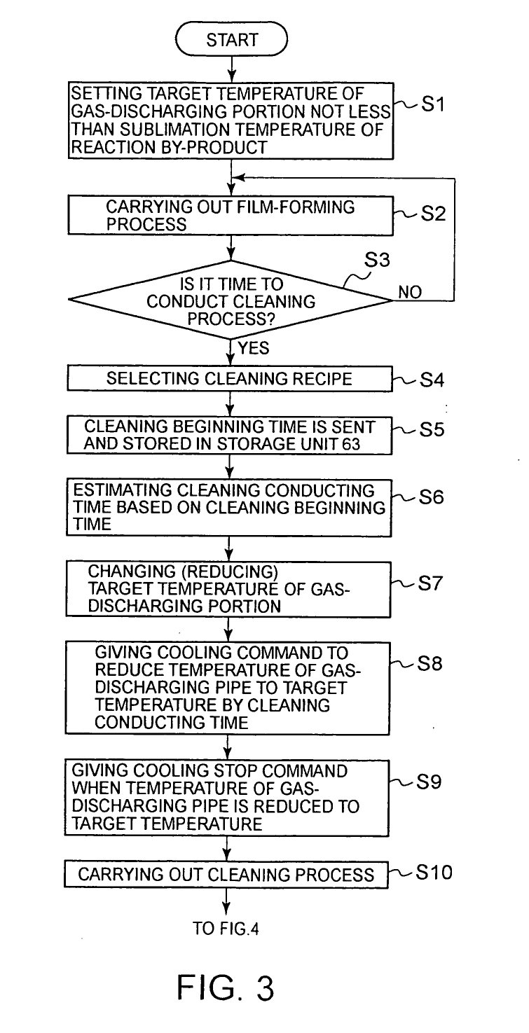

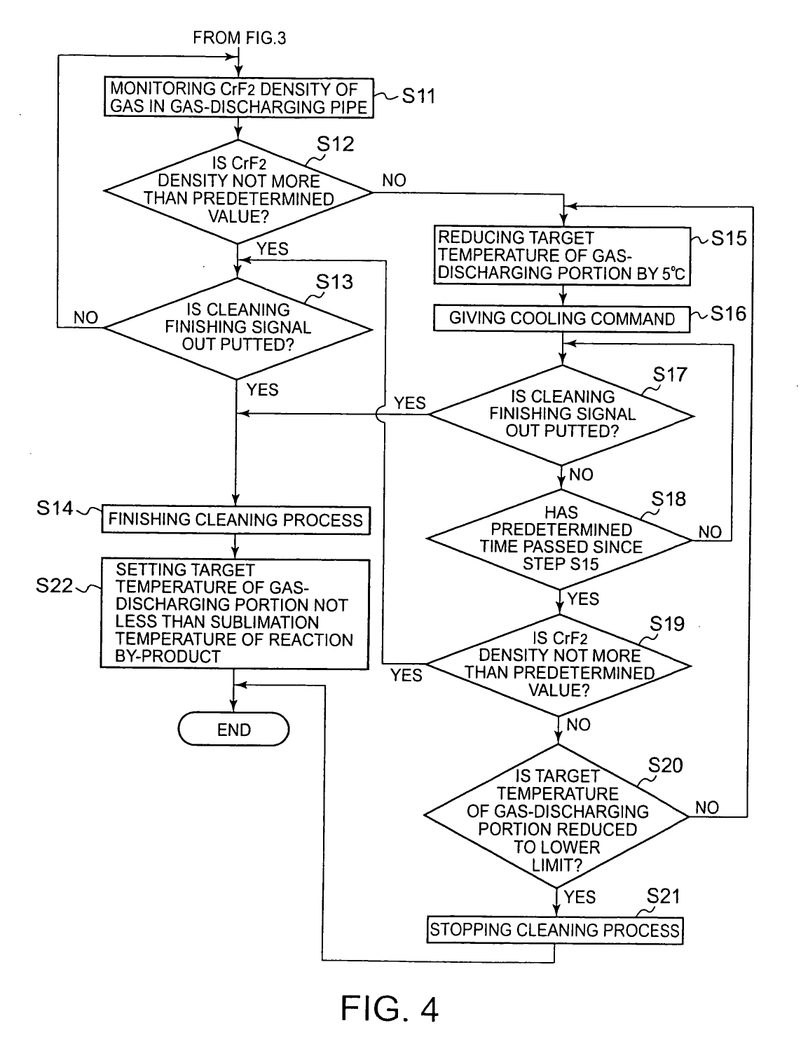

An operation of the processing system composed as above will be described with reference to the flowcharts in FIGS. 3 and 4. First of all, an operation at a film-forming process by means of the LP-CVD unit will be described.

As shown in STEP S1, at a film-forming process, the target temperature of the gas-discharging portion, for example, the target temperatures of the inside wall of the gas-discharging pipe 3 are set to be not less than the sublimation temperature of the reaction by-product by means of the gas-discharging-portion temperature-control-operation determining program 64 of the controlling unit 6, and the target temperatures are outputted to the gas-discharging-portion temperature controller 7. The gas-discharging-portion temperature controller 7 conducts a PID-control to an output of the gas-discharging portion heater 33 based on the target temperatures. In this example, the film-forming process is a process wherein a silicon nitride film is formed by causing dichloro-silane (SiH₂Cl₂) and ammonia (NH₃) to react on each other. Then, the sublimation temperature of ammonium chloride (NH₄Cl), which is a reaction by-product, is 150° C. and hence the target temperatures are, for example, set to be 200° C.

The gas-discharging-portion thermocouples 35 deliver detected temperatures of the gas-discharging pipe 3 to the gas-discharging-portion temperature controller 7. The gas-discharging-portion heater 33 is controlled based on a signal sent by the gas-discharging-portion temperature controller 7. The first cooling unit 100 usually does not operate at the film-forming process. The Q-mass 36 sends data of discharged gas components at the film-forming process to the storage unit 63 periodically (in the present embodiment, every ten seconds).

In the LP-CVD unit, as shown in STEP S2, a predetermined number of wafers, which are substrates on each of which a film is formed, are transferred onto and held by the wafer boat 12, and conveyed into the reaction container composed of the reaction pipe 1 and the manifold 11 by an elevation of the boat elevator 17. The lower end opening (a furnace opening) of the manifold 11 is closed by the lid 13. Next, the main valve 32 is opened, and the inside of the reaction container is exhausted into a vacuum by means of the vacuum pump 31. When the pressure in the reaction container reaches a predetermined pressure, for example, about 0.1 Pa, the main valve 32 is closed, and then it is confirmed whether the pressure in the reaction container as a closed space rises or not. When a pressure rise is confirmed at that point, atmospheric air may be involved in the film-forming process. In that case, a desired silicon nitride film cannot be obtained.

Furthermore, by means of the heater 2, the inside of the reaction container is heated up to a predetermined process temperature, for example, a temperature selected from between about 500° C. and 800° C. After that, a process gas is introduced from the process-gas supplying pipe. The process-gas supplying pipe(s) is always ready in accordance with kinds of process gases to be introduced. Usually, when a silicon nitride film is formed, dichlorosilane and ammonia are generally used. In this example, these gases are supplied into the reaction container from the process-gas supplying pipes 21 and 22, respectively, and then the film-forming process is conducted for a predetermined time. At that time, ammonium chloride, which is a reaction by-product, is produced and flows into the exhaust gas. However, since the inside of the gas-discharging pipe 3 is heated not less than the sublimation temperature of the ammonium chloride, the ammonium chloride is discharged out without adhering to the gas-discharging pipe 3, and is captured at a not-shown trap.

After the film-forming process, a residual gas which remains in the reaction container is purged by using an N₂ gas, which may be supplied through a not-shown gas supplying pipe. Thereafter, the boat elevator 17 is moved down and the wafer boat 12 is conveyed out.

Concurrently with forming the films on the wafers, silicon nitride films may adhere to parts exposed to the inside atmosphere of the reaction container, such as, for example, the wafer boat 12, the inside wall of the outer pipe 1b, and the inner pipe 1a. When the processing unit is used for a long time, the film thickness of such a silicon nitride film is increased. Such a silicon nitride film causes a contamination and/or a dust, and leads to a quality inferiority of the product (device), such as spots on a formed film, conductive hindrance, insulation failure, and so on. Accordingly, in order to prevent the quality inferiority of the device, it is necessary to periodically conduct a cleaning process to the LP-CVD unit for forming a nitride film. Therefore, as shown in STEP S3, the system controlling unit 5 judges whether it is a time to conduct the cleaning process or not, for example, whether an accumulative film thickness of a silicon nitride film reaches a set valve or not. When it reaches the set valve, for example, a cleaning recipe is automatically selected and the cleaning process is begun. Alternatively, an indication regarding the cleaning process is shown on an operation screen of the unit. Alternatively, it raises an alarm and urges the operator to conduct the cleaning process.

Next, a method for cleaning the LP-CVD unit will be described in detail. In the first place, as shown in STEP S4 for example, when the cleaning recipe is selected by the system controlling unit 5 and an operation according to the cleaning recipe begins, the beginning time of the cleaning process is delivered form the system controlling unit 5 to the controlling unit 6 to be stored in the storage unit 63 (STEP S5). Then, according to the gas-discharging-portion temperature-control-operation determining program 64 as the gas-discharging-portion temperature-control-operation determining unit, the controlling unit 6 estimates a conducting time of the cleaning process (a time when a cleaning gas is introduced) based on the beginning time of the cleaning process (the above-mentioned time when the cleaning recipe has been selected) (STEP S6), and changes the target temperatures of the inside wall of the gas-discharging pipe 3, which is the gas-discharging portion, from the temperature not less than the sublimation temperature of the ammonium chloride to an appropriate temperature at which the inside wall is not corroded by the cleaning gas, for example, a temperature at which the stainless-steel surface composing the inside wall is not impaired by the fluorine (for example 25° C.) (STEP S7) (to lower the temperature than the target temperature at the film-forming process). The changed target temperature(s) is sent from the controlling unit 6 to the gas-discharging-portion temperature controller 7. Concretely, the target temperature(s) suitable for the cleaning process is read out from the table 66, and sent to the gas-discharging-portion temperature controller 7.

In addition, in the example, for example, a time sixty minutes after the beginning time of the cleaning process is estimated as the conducting time of the cleaning process. Then, a cooling operation command is sent from the controlling unit 6 to the gas-discharging-portion temperature controller 7 so that the temperature of the inside wall of the gas-discharging pipe 3, which is the discharging portion, falls to the target temperature at the conducting time of the cleaning process. Thereby, the gas-discharging-portion temperature controller 7 give an operation command to cool the cooling water and to cause the same to flow to, for example, the chiller unit 42 so that the first cooling unit 100 conducts a cooling operation (STEP S8). For example, when the conducting time of the cleaning process is estimated according to the program 64, it is judged whether the temperature of the inside wall of the gas-discharging pipe 3 falls to the target temperature by the conducting time of the cleaning process or not, based on the temperature of the inside wall of the gas-discharging pipe 3 at that time, the target temperature, and the cooling condition (the temperature of the cooling medium, the flow rate of the cooling medium, and the like) at that time. Depending on the result of the judgment, the second cooling unit 200 is used in addition to the first cooling unit 100. Alternatively, such a command as to increase the flow rate of the cooling medium is given to the chiller unit 42.

The first cooling unit 100 starts a cooling operation when it receives the cooling operation command. That is, the cooling water is caused to flow through the inside of the cooling pipe 41 to forcibly cool the gas-discharging pipe 3. When the temperature detection values by means of the gas-discharging-portion thermocouples 35 fall to a temperature close to the target temperature, the controlling unit 6 outputs a stopping command of the cooling operation to the gas-discharging-portion temperature controller 7 (STEP S9). Thereby, the cooling operation by means of the first cooling unit 100, for example, the flow of the cooling water, is stopped. In order to cool the gas-discharging pipe 3, the cooling command may be given to the second cooling unit 200 in addition to the first cooling unit 100 so that a cooling gas may be supplied into the gas-discharging pipe 3 from the cooling gas line 43.

On the other hand, in the LP-CVD unit, when the cleaning recipe is selected, the wafer boat 12 on which no wafer is placed is conveyed into the reaction container, and the lower end opening of the manifold 11 is closed by means of the lid 13. Thereby, a part from the reaction container to the main valve 32 of the gas-discharging pipe 3 becomes a closed space. Next, the main valve 32 is opened, and the inside of the reaction container is vacuumed by the vacuum pump 31. When the pressure in the reaction container falls down to a limit, for example about 0.1 Pa, the main valve 32 is closed. Then, it is confirmed whether there is any pressure rise in the reaction container as a closed space or not. If a pressure rise is confirmed at that point, it means that the atmospheric air may be involved in the cleaning process. In this case, there is a danger that the cleaning gas react with the air.

Next, by means of the heater 2, the temperature in the reaction container is heated up to the cleaning temperature, for example 300° C. After the temperature in the reaction container reaches the cleaning temperature, a cleaning gas (a dry etching gas) such as a fluorine gas and a hydrogen fluoride gas is introduced through the cleaning-gas supplying pipe 23 into the reaction container, and hence the cleaning process is conducted (STEP S10). By the cleaning gas, silicon nitride films adhering to the wafer boat 12, the inside wall of the outer pipe 1b, the inner pipe 1a, and the like, are etched and removed.

Additionally, by means of the Q-mass 36, density of a component which serves as an indicator to show degree of corrosion of the gas-discharging pipe 3 is monitored in the gas flowing through the gas-discharging pipe 3. In this example, density of CrF₂, which is the reaction by-product between the stainless steel which is a material of the gas-discharging pipe 3 and the cleaning gas, is detected as an ion current corresponding to CrF₂. The detection value is memorized periodically, for example every ten seconds, in the storage unit 63 of the controlling unit 6 (STEP S11). According to the gas-discharging-portion temperature-control-operation determining program, it is judged whether the density of CrF₂ is more than a predetermined density or not (STEP S12). When the density of CrF₂ is not more than the predetermined density, it is judged whether a finishing signal of the cleaning process is outputted or not (STEP S13). When it is not outputted, STEP S11 and STEP S12 are repeated. When the finishing signal of the cleaning process is outputted, the system controlling unit 5 closes the valve V3 provided at the cleaning-gas supplying pipe 23 to finish the cleaning process (STEP S14).

On the other hand, when the density of CrF₂ is judged to be over the predetermined density in STEP S12, a command to lower the target temperature by a predetermined temperature, for example by only 5° C., is given, by the gas-discharging-portion temperature-control-operation determining program 64 to the gas-discharging-portion temperature controller 7, that is, a target temperature which is only 5° C. lower is outputted (STEP S15). Thereby, the gas-discharging-portion temperature controller 7 sends a new cooling operation command to the first cooling unit 100 (STEP S16). When the operation of the first cooling unit 100 is modified, the temperature of the gas-discharging pipe 3 is further lowered. Accordingly, the reaction in the gas-discharging pipe 3 can be inhibited. Here, as described above, when the heated portion of the inside wall of the gas-discharging pipe 3 is divided into a plurality of segments and a temperature of each segment is independently controlled, each target temperature of each segment to be heated is changed to be lower by only 5° C.

Furthermore, when a condition wherein the density of CrF₂ exceeds the set value continues, for example, when the ion current corresponding to the density of CrF₂ is over 1E-9(A), steps to lower the target temperature are repeated. Concretely, after the STEP S16, it is judged whether the finishing signal of the cleaning process is outputted or not by STEP S17. When the finishing signal of the cleaning process is outputted, the operation proceeds to STEP S14 and the cleaning process is finished. When the finishing signal of the cleaning process is not outputted, for example, it is judged whether a predetermined time has passed since STEP S15 in which the command to lower the target temperature by 5° C. is given (STEP S18). When the predetermined time has passed, it is judged again whether the density of CrF₂ is not more than the predetermined density by STEP S19. At this point, if the density of CrF₂ is not more than the predetermined density, STEP S13 is started. When the density of the CrF₂ is still above the predetermined density, the gas-discharging-portion temperature-control-operation determining program 64 of the control unit 6 further repeats the steps to lower the target temperature of the gas-discharging portion by the predetermined temperature, for example, 5° C. Even if the inside wall temperature of the gas-discharging pipe 3 is lowered to a predetermined lower limit temperature, for example, to a temperature 10° C. higher than the cooling fluid of the first cooling unit 100, if the density of CrF₂ does not become not more than the set value, it is judged that it is impossible to control the reaction between the cleaning gas and the gas-discharging-portion stainless-steel member in the present system, and then the cleaning process is stopped. That is, in the flowchart, after STEP S19, it is judged whether the target temperature of the gas-discharging portion is lowered to the predetermined lower-limit temperature or not (STEP S20). If it is not lowered to the predetermined lower-limit temperature, the operation returns to the STEP S15 so that the target temperature is lowered, for example by 5° C. If it is lowered to the predetermined lower-limit temperature, the cleaning process is stopped in STEP S21.

The stop of the cleaning process is conducted in such a manner that the gas-discharging-portion temperature-control-operation determining program 64 sends a cleaning abortion command to the system controlling unit 5 and a cooling stop command to the first cooling unit 100, respectively. The system controlling unit 5 immediately doses the valve V3 of the cleaning-gas supplying pipe 23 and ceases the cleaning process, when it receives the cleaning abortion command. In addition, the first cooling unit 100 immediately stops the cooling operation when it receives the cooling stop command.

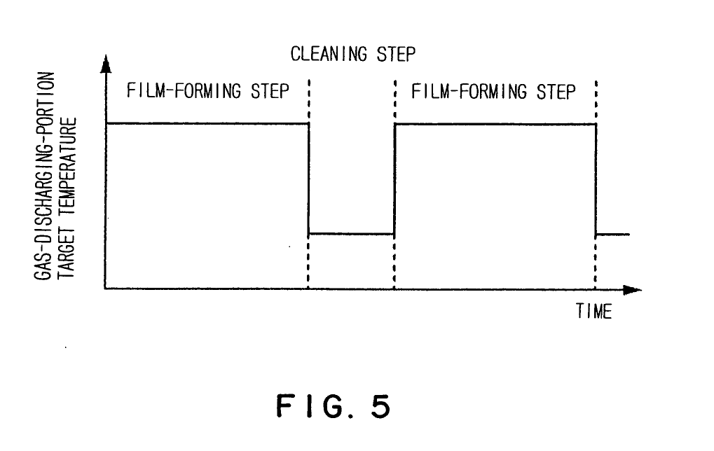

When the cleaning process in the reaction container is finished, the cleaning gas in the reaction container is replaced with another gas introduced through a not-shown gas supplying pipe, for example an N₂ gas. On the other hand, the gas-discharging-portion temperature-control-operation determining program 64 changes the target temperature of the gas-discharging portion to a temperature not less than the sublimation temperature of the reaction by-product (STEP S22). The changed target temperature of the gas-discharging portion is outputted to the gas-discharging temperature controller 7. The relationship among the target temperature of the gas-discharging portion, the film-forming process and the cleaning process is shown in FIG. 5.

According to the above embodiment, since the target temperature of the gas-discharging portion is set to be not less than the sublimation temperature of the reaction by-product at the film-forming process, it is possible to prevent the reaction by-product from adhering to the gas-discharging portion (concretely, the inside wall of the gas-discharging pipe 3 that is the gas-discharging-way member), while the durable term of the gas-discharging-way member is lengthened, because the target temperature is lowered to an appropriate temperature at which corrosion of the stainless-steel composing the gas-discharging portion by the cleaning gas can be sufficiently inhibited at the cleaning process. In addition, by inhibiting the corrosion of the metallic portion, metallic contamination to the wafers may be prevented. Furthermore, since the temperature of the gas-discharging portion is lowered to a temperature suitable for the cleaning process, for example by forcibly cooling the gas-discharging pipe 3 by means of the cooling fluid, when the film-forming process is switched to the cleaning process, temperature fall of the gas-discharging portion is immediately achieved, and the cleaning process is immediately started.

Further, since the condition of the reaction between the stainless-steel member composing the gas-discharging portion and the cleaning gas is adapted to be monitored by means of the density of the predetermined component, for example CrF₂, in the gas flowing through the gas-discharging pipe 3 and the temperature of the gas-discharging pipe 3 is adapted to be lowered when the density becomes higher than the predetermined density, the corrosion of the stainless-steel member composing the gas-discharging portion can be surely inhibited. Note that by taking such a composition, it is possible to detect the corrosion instantaneously when not only the gas-discharging portion but also another stainless-steel member such as the manifold 11 or the like are corroded.

In the embodiment described above, the Q-mass is used as a reaction detection unit for detecting the reaction condition between the inside wall of the gas-discharging pipe 3 and the cleaning gas. However, it is possible to predict the reaction condition from changes in the output of the gas-discharging-portion heater 33 by monitoring the output of the gas-discharging-portion heater 33. (When the reaction between the inside wall of the gas-discharging pipe 3 and the cleaning gas occurs, the output is decreased because of another reaction with the reaction by-product.) In this case, the output of the gas-discharging-portion heater 33 needs to be sent periodically, for example every 10 seconds, to the storage unit 63, and a program to monitor the output of the gas-discharging-portion heater 33 and to predict whether the reaction occurs or not is needed.

In the embodiment described above, the mixture gas of the fluorine gas and the hydrogen fluoride gas is used as a cleaning gas. When such a much corrosive fluorine gas is used, the present invention is an effective technology. However, the present invention is not confined to the case wherein such a gas is used as a cleaning gas, and the present invention can be also applied to a case wherein a cleaning process is conducted by using another gas.

As described above, the preferable embodiment of the present invention has been described with reference to the accompanying drawings, but the present invention is not confined to this composition. For example, the embodiment described above is adapted to inhibit the corrosion of the stainless-steel member of the gas-discharging portion by the cleaning gas, but it is possible to apply the present invention in order to inhibit corrosion of the stainless-steel member used for the lid 13 that closes the furnace opening of the LP-CVD unit or the manifold 11. In this case, target temperatures of these members are recorded in the table 66 in addition to the target temperature(s) of the gas-discharging portion, for each process.

Moreover, in the embodiment described above, the controlling unit 6 which serves as a management controlling unit is composed of computers different from the system controlling unit 5. However, the system controlling unit 5 may also serve as the management controlling unit. In this case, the target temperature(s) of the gas-discharging portion or the like is adapted to be changed by the system controlling unit 5.

Furthermore, while the present invention has been described taking the LP-CVD unit for forming a silicon nitride film for example, the present invention can be applied to, for example, a plasma CVD unit for forming a silicon nitride film, and an aluminum etching unit. In short, the present invention can be applied to a unit wherein a member such as a gas-discharging portion or the like has to be heated in order to prevent adhesion of reaction by-products and wherein the member is exposed to a corrosive gas at a cleaning process.

1. A processing system comprising:
a reaction container in which a substrate to be processed is placed,
a process-gas supplying mechanism that supplies a process gas into the reaction container at a process to the substrate,
a cleaning-gas supplying mechanism that supplies a corrosive cleaning gas into the reaction container at a cleaning process,
a gas-discharging-way member connected to the reaction chamber,
a heating unit that heats a specific portion of the reaction container and the gas-discharging-way member,
a temperature detecting unit that detects a temperature of the specific portion,
a temperature controlling unit that controls the heating unit based on a detection value detected by the temperature detecting unit in such a manner that the specific portion becomes to a predetermined target temperature, and
a temperature changing unit that changes the target temperature between at the process to the substrate and at the cleaning process,
wherein
by means of the temperature changing unit, the target temperature is set to a temperature at which adhesion of reaction by-products to the specific portion may be inhibited, at the process to the substrate, while the target temperature is set to a temperature at which corrosion of the specific portion may be inhibited, at the cleaning process.

2. A processing system according to claim 1, further comprising
a cooling unit that cools the specific portion.

3. A processing system according to claim 1, further comprising
a reaction detecting unit that detects a reaction between the specific portion and the cleaning gas at the cleaning process.

4. A processing system according to claim 3, wherein
the temperature changing unit is adapted to change the target temperature at the cleaning process into a lower target temperature, when the reaction detecting unit detects a reaction between the specific portion and the cleaning gas.

5. A processing system according to claim 4, wherein
supply of the cleaning gas by means of the cleaning-gas supplying mechanism is adapted to be stopped, when the temperature changing unit changes the target temperature at the cleaning process into a predetermined lower-limit temperature.

6. A processing system according to claim 1, further comprising
a system controlling unit that controls the process to the substrate caused by the process gas, and
a management controlling unit that conducts an overall step management,
wherein
the temperature changing unit is integrated with the management controlling unit.

7. A processing system according to claim 6, wherein
the management controlling unit is adapted to determine a introduction timing of the cleaning gas based on information sent from the system controlling unit, and
the temperature changing unit is adapted to change the target temperature by the introduction timing.

8. A processing system according to claim 1, wherein
the cleaning gas includes a fluorine gas.

9. A processing system according to claim 1, wherein
the specific portion is a portion of the gas-discharging-way member or a whole portion of the gas-discharging-way member

10. An operating method of a processing system including:
a reaction container in which a substrate to be processed is placed,
a process-gas supplying mechanism that supplies a process gas into the reaction container at a process to the substrate,
a cleaning-gas supplying mechanism that supplies a corrosive cleaning gas into the reaction container at a cleaning process,
a gas-discharging-way member connected to the reaction chamber, and
a heating unit that heats a specific portion of the reaction container and the gas-discharging-way member,
the operating method comprising:
a step of conveying the substrate into the reaction container,
a step of heating the specific portion to a temperature at which adhesion of reaction by-products to the specific portion may be inhibited,
a step of supplying the process gas into the reaction container to conduct a process to the substrate,
a step of conveying out the substrate from the reaction container,
a step of setting the specific portion to a temperature at which corrosion of the specific portion may be inhibited, and
a step of supplying the cleaning gas into the reaction container to conduct a cleaning process to the reaction container.

11. A method according to claim 10, wherein
the step of setting the specific portion to a temperature at which corrosion of the specific portion may be inhibited includes a step of forcibly cooling the specific portion.

12. A method according to claim 10, wherein
the step of supplying the cleaning gas into the reaction container to conduct a cleaning process to the reaction container includes a step of monitoring a reaction between the specific portion and the cleaning gas.

13. A method according to claim 12, wherein
the step of supplying the cleaning gas into the reaction container to conduct a cleaning process to the reaction container includes a step of lowering the temperature of the specific portion further more when the reaction between the specific portion and the cleaning gas is detected.

14. A method according to claim 13, wherein
the step of supplying the cleaning gas into the reaction container to conduct a cleaning process to the reaction container includes a step of stopping the supply of the cleaning gas by means of the cleaning-gas supplying mechanism when the temperature of the specific portion is lowered to a predetermined lower-limit temperature.
